(19) United States
(12) Patent Application Publication
(10) Pub. No.: US 2013/0016528 A1
(43) Pub. Date: Jan. 17, 2013

(54) ENHANCED COLOR GAMUT LED BACKLIGHTING UNIT

(71) Applicant: Kevin Joseph Hathaway, Saratoga, CA (US)

(72) Inventor: Kevin Joseph Hathaway, Saratoga, CA (US)

(21) Appl. No.: 13/547,037

(22) Filed: Jul. 11, 2012

Related U.S. Application Data
(60) Provisional application No. 61/572,140, filed on Jul. 11, 2011.

(51) Int. Cl. F21V 8/00

(52) U.S. Cl. 362/612

(57) ABSTRACT

A method for operating a backlighting unit adapted for illuminating a printed graphic with light emitted from an illumination surface of a light guide. The method includes the step of arranging a plurality of LEDs so that light emitted therefrom impinges upon an input surface of the light guide. The method specifically requires that the LEDs emit light that is roughly equivalent to solar illumination of 6500K CCT yet enhanced in the blue and the red portions of the spectrum thereby producing light in the range of 7500K CCT to 9000K CCT.

### CLAIM OF PROVISIONAL APPLICATION RIGHTS

This patent application claims the benefit of U.S. Provisional Patent Application No. 61/572,140 filed on Jul. 11, 2011.

### BACKGROUND

1. Technical Field

The present disclosure relates generally to sources for backlighting printed graphics, and, more particularly, to light emitting diode (“LED”) backlighting sources.

2. Background Art

Graphic artists often can choose between illuminating an image from the front or from the rear. Illuminating an image from the rear (“backlighting”) provides numerous benefits. The most immediate benefit is that backlighting avoids any need for adding external lighting sources to view the image. Also, the brightness of the image is no longer tied to the ambient brightness of the viewing environment, presumably and typically, some kind of a room. But, whether front lighting or backlighting an image, the actual colors and brightness a viewer will see result from the absorptive characteristics of the image convolved with the spectral and intensity characteristics of the illumination source.

When illuminating an image from the rear, graphic artists use a device often called a “light box” by graphic artists because of the history that graphics, typically advertising graphics, have been backlit using one or more fluorescent tubes arranged in a rectangular box with a thick plastic diffuser interposed between the tubes and the graphic image. These light boxes are used to backlight photographic or other transparencies as well as LCD panels.

Obviously, in a completely dark room, no matter what the characteristics of the inks or paints used to produce an image, the image will have no perceivable color or brightness because there is no light available to view it. Therefore, it is well understood that the perceived color of any non-emissive object will be strongly affected by the spectral characteristics and brightness of the light used for its illumination.

Of course, not considered in this discussion is the possibility that a luminescent paint or ink was used which was recently energized by an external source or that any other electronic or electronic display technology was employed to produce the image. The following disclosure is confined to printed and or hand painted graphic images.

Over the last few years white LEDs have gained prominence as the preferred solid state light source both for LCD backlighting and for general illumination. The vast majority of these white LEDs are made by covering one or more high output blue LED die with a single yellow phosphor. While this design approach is adequate for many lighting situations, the spectral output of the blue and yellow combination generally produces an incomplete coverage of the full range of visible wavelengths. The color band that is most compromised with such LED light sources is in the red, especially the longer wavelength red.

Using these single phosphor white LEDs to illuminate graphic images, whether by front lighting or backlighting, is often judged to be unsatisfactory because of the resulting poor color rendition in the red. In LCD backlighting, there have recently been introduced white LEDs which use a binary, green and red, phosphor mixture. This approach improves the color gamut of the LCD and also increases the overall transmission of the LED light through the color filters of the display as compared to an LED coated with a single phosphor material.

The peak wavelength of the red phosphor is typically aligned (as best practical) with the transmission peak of the red color filters in the LCD which generally peaks at around 620-630 nm. This design works well for LCD backlighting and results in a display with a color gamut that is typically at least 72% of the NTSC specification as defined by the CIE 1931 color space. However, for lighting, particularly backlighting, printed and painted graphics, even this expanded gamut LED source still leaves the very long wavelength reds (i.e., 630-700 nm) under represented.

One of the other considerations in backlighting for LCD displays is to maximize the overall power efficiency of the lighting system to minimize the system operating power. It has been recognized that maximizing overall brightness and, particularly, extending the lighting system color gamut into the long wavelength reds conflicts with comparatively system power efficiency. However, it is believed that an ability to produce strikingly aesthetic images justifies an improved lighting system's higher power consumption.

The human eye evolved to detect color primarily under conditions of daylight illumination. The correlated color temperature (“CCT”) of mid-day sunlight in Northern and Western Europe is approximately 6500K CCT. Most humans prefer the color balance that results from daylight illumination. “Natural lighting” is a common term, given wherein a room is lit by sunlight or an artificial source that spectrally matches sunlight.

A problem with natural lighting is that the vast majority of artificial light sources used to simulate sunlight are blackbody radiators (“BBRs”). Boosting an artificial light source's CCT of upward to enhance the blue light production diminishes the source's emission of red light. Conversely, if a BBR is adjusted to enhance its production of long wavelength red light, the blue end of the source's spectrum is unsatisfactorily diminished.

Lastly, it is well known that the performance and life of LEDs is adversely affected by their heat generation. This often limits the amount of power that can be employed in energizing the LED's operation thereby limiting their brightness needed for illuminating a bright, colorful image. This problem is further exacerbated by the fact that high quality, backlit images are most often installed in a wooden frame or made from other material that is a poor thermal conductor, and that the backlighting unit is hung on a wall, which is also poorly thermally conducting.

### BRIEF SUMMARY

An object of the present disclosure is to provide an improved backlight source for illuminating printed graphics.

An object of the present disclosure is to provide an improved backlight source for illuminating printed graphics that individuals viewing the printed graphics find to appear natural looking but enhanced in a natural appearing way.

An object of the present disclosure is to provide an improved backlight source for illuminating printed graphics having ink depths are adjusted for rear illumination whereby upon illumination with the improved backlight source the printed graphics appear almost more real than real life.

An object of the present disclosure in producing an output spectrum from the backlight source that is roughly equivalent to solar illumination of 6500K CCT yet enhanced in the blue and the red portion of the spectrum.

Another object of the present invention is to provide backlighting unit that efficiently dissipates heat produced by LEDs.

Another object of the present invention is to provide backlighting unit having a path by which heat generated by the LEDs is dissipated therefrom by conducting and spreading the heat over the back of the backlighting unit behind the graphic image mounted thereon.

Briefly, disclosed herein is a method for operating a backlighting unit adapted for illuminating a printed graphic with light emitted from an illumination surface of a light guide. The method includes the step of arranging a plurality of LEDs so that light emitted therefrom impinges upon an input surface of the light guide. The method specifically requires that the LEDs emit light that is roughly equivalent to solar illumination of 6500K CCT yet enhanced in the blue and the red portions of the spectrum thereby producing light in the range of 7500K CCT to 9000K CCT.

The present disclosure's LEDs are not blackbody radiators. The spectrum of the disclosed LEDs results from a blend of two (2) or more phosphors specifically selected for down-converting predetermined amounts of blue LEDs' radiation thereby providing a cost effective, efficient and convenient light source with enhanced color rendering properties in the short wavelength blue and long wavelength red that still appears “natural”, only more-so.

A advantage over prior art is that it allows generating substantial luminous flux from the LEDs in a very thin (i.e., less than 12 mm thick) backlighting unit.

An advantage of the present disclosure is that if sufficient source brightness is available and if the image is appropriately printed or painted with vivid inks, colors of the printed graphic backlit in accordance with the present disclosure are quite striking and often very pleasing.

These and other features, objects and advantages will be understood or apparent to those of ordinary skill in the art from the following detailed description of the preferred embodiment as illustrated in the various drawing figures.

### BRIEF DESCRIPTION OF THE DRAWINGS

FIG. 1 is an elevational view depicting backlight illuminator that, in accordance with the present disclosure, includes a light guide;

FIG. 2 is a perspective view depicting the backlight illuminator in accordance with the present disclosure; and

FIG. 3 is a graph comparing normalized light output from a typical white light LED with normalized light output from the enhanced spectrum LED disclosed herein.

### DETAILED DESCRIPTION

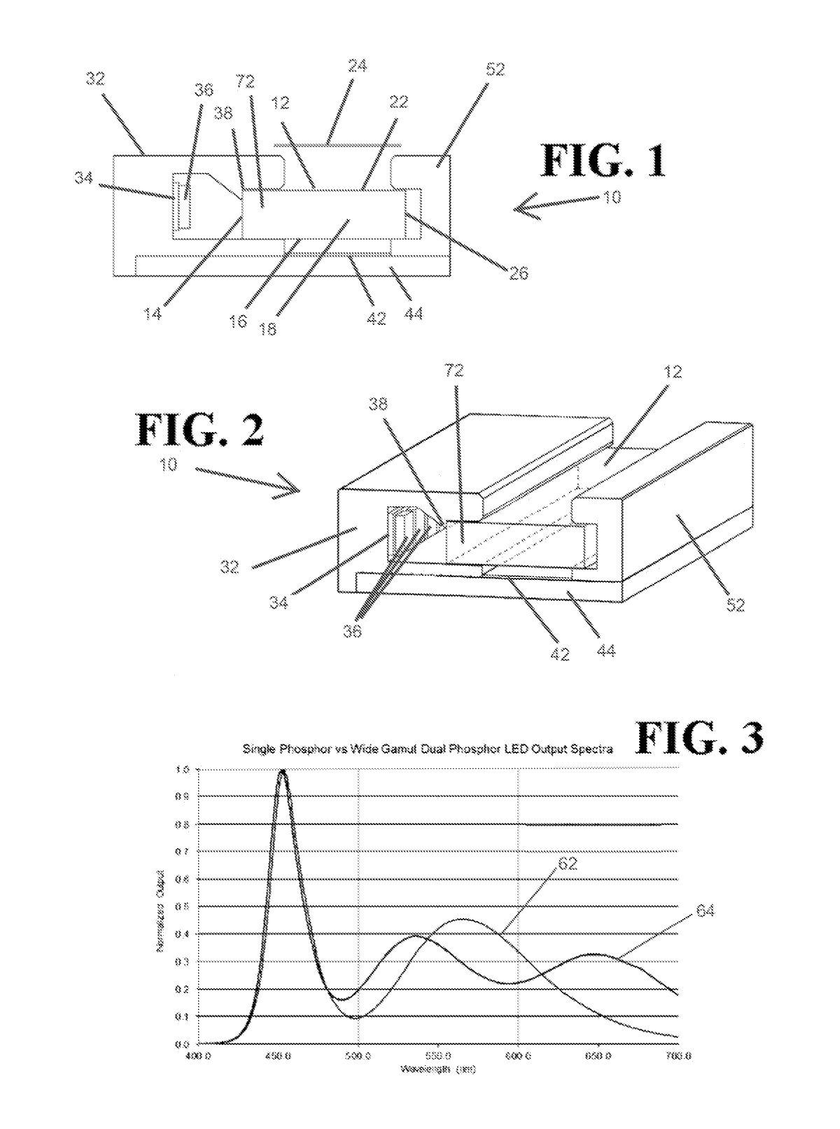

FIG. 1 depicts a backlighting unit, referred to by the general reference character 10, that includes a conventional light guide 12. The light guide 12 may be either a planar as depicted in FIG. 1, or wedged-shaped, and is made from a transparent material such as glass or plastic, preferably transparent acrylic plastic. The light guide 12 includes an input surface 14 through which light from a light source enters the light guide 12. Some types of light guides 12 include an extraction surface 16 that redirects out of the light guide 12 light that enters the light guide 12 through the input surface 14 to then propagates within the light guide 12. Other types of light guides 12 use the material of the light guide 12 for redirecting out of the light guide 12 light that enters the light guide 12 through the input surface 14 to then propagates within the light guide 12. The material of this second type of light guide 12 is sometime identified as an extraction volume 18 of the light guide 12. Although both the extraction surface 16 and the extraction volume 18 could be used in combination, typically light guides 12 include either an extraction surface 16 or an extraction volume 18, but not both. Lastly, the light guide 12 includes an illumination surface 22 which is the primary surface through which light leaves the light guide 12. When used in a light box, the illumination surface 22 faces a translucent printed graphic 24 which light leaving the light guide 12 through the illumination surface 22 illuminates. Other surfaces of the light guide 12 that are not the input surface 14, extraction surface 16 or the illumination surface 22 are called passive surfaces 26 of the light guide 12.

Referring now to both FIGS. 1 and 2, the backlighting unit 10 preferably includes an extruded, thermally conductive thermal housing 32 that receives both the light guide 12 and a subassembly printed circuit board 34 that carries an extended array of LEDs 36. Preferably, the thermal housing 32 is made from aluminum and fits securely over the input surface 14 of the light guide 12 with edges of the light guide 12 being captured and positioned by the thermal housing 32. The thermal housing 32 includes a mechanical stop 38 that provides overall positioning for the light guide 12, particularly with respect to the LEDs 36. To avoid creating visual defects viewable on the illumination surface 22, the thermal housing 32 separates the light guide 12 from a diffusive back reflector 42 that is located adjacent to the extraction surface 16 thereby preventing optical contact with the back reflector 42. The back reflector 42 redirects light propagating away from the illumination surface 22 back towards the illumination surface 22. The back reflector 42 should be diffuse, white and as highly reflective as practicable.

Light guides that employ a printed pattern for creating the extraction surface 16 almost always orient the light guide 12 with the extraction surface 16 on the bottom. Such a printed pattern usually roughens the extraction surface 16 sufficiently to minimize the possibility of optical contact between the back reflector 42 and the light guide 12. However, as described above some types of light guides 12 create an extraction volume 18 that redirects the light out of the light guide 12 through the illumination surface 22 by including a small amount of diffusive material in the material of the light guide 12. The surface of this second type of light guide 12 is usually smooth making it more susceptible to assembly defects that produce contact with other materials such as the back reflector 42. The configuration of the thermal housing 32 depicted in FIGS. 1 and 2 accommodates both types of light guides 12.

To efficiently dissipate generated by the LEDs 36 the backlighting unit 10 also includes an aluminum thermal plate 44 that is between 1.0 mm to 4.0 mm thick, preferably about 2.0 mm thick. The thermal plate 44 is preferably attached mechanically to the thermal housing 32 by a thin adhesive layer. Alternatively, the thermal housing 32 could have multiple threaded holes drilled thereinto along the length of the thermal housing 32 which mate with corresponding drilled holes that pierce the thermal plate 44. Neither set of holes appear in any of drawing FIGS. For this second configuration of thermal housing 32 and thermal plate 44, threaded fasteners passing through the thermal plate 44 and screwed into the holes drilled into the thermal housing 32 secure the thermal plate 44 to the thermal housing 32. However, attaching the thermal plate 44 to the thermal housing 32 with an adhesive bond rather than with screws is less expensive.

Also illustrated in FIGS. 1 and 2 is a second extrusion 52 included in the backlighting unit 10 for advantageously capturing and positioning the passive surfaces 26 of the light guide 12 thereby providing together with the thermal housing 32 a frame that supports the light guide 12. The second extrusion 52 provides it a slight elevation raising the light guide 12 slightly above the surface of the back reflector 42. In the embodiment depicted in FIGS. 1 and 2, the second extrusion 52 is also adhesive bonded to the thermal plate 44. However, because the second extrusion 52 does not extend below the surface of the second extrusion 52, as does the thermal housing 32, the dimensional tolerance required for sizing the second extrusion 52 can be rather coarse thereby reducing manufacturing coast.

Preferably, the printed circuit board 34 is less than 0.6 mm thick, and it is made of a substrate material that is more thermally conductive than FR4. The printed circuit board 34 is mechanically and thermally bonded to an inner surface of the thermal housing 32. The thermal housing 32 positions the input surface 14 of the light guide 12 a fixed, specified distance from the array of LEDs 36 mounted on the printed circuit board 34.

Referring now to FIG. 3, the graph appearing there provides a comparison between normalized light output:

1. from a typical white light LED having a CCT of 6500K indicated by a curve 62; and

2. from the enhanced 8500K CCT wide gamut spectrum LED 36 disclosed herein indicated by a curve 64.

Based on visual appearance, the LEDs 36 mounted on the printed circuit board 34 may properly be called “white” LEDs. However, the LEDs 36 use a phosphor blend that is formulated to produce a CCT in the range of 7500-9000K, preferably near 8500K while also including a red phosphor with an emission peak preferably in the range of 640-660 nm. The emission peak of blue LEDs that are coated with this phosphor blend and which excite emission from the phosphor blend typically emit light in the range of 440-470 nm. As illustrated in FIG. 3, the LED's blue light emission lies in the overall output spectrum of light produced by the LEDs 36. Note further the enhanced emission of long wavelength red light depicted in FIG. 3 produced by the LEDs 36.

It is important to note that one skilled in the art might consider using a single phosphor LED selecting an output of 8500K CCT or more anticipating that this will produce the same quality result as the LEDs 36 disclosed herein. In reality, while such an LED selection will produce improved blue colors in the printed graphic 24, red colors will lack the richness and saturation obtained with the present disclosure's LEDs 36.

Although the present invention has been described in terms of the presently preferred embodiment, it is to be understood that such disclosure is purely illustrative and is not to be interpreted as limiting. For example, those skilled in the art will recognize that alternate embodiments of the preceding mechanical configuration are possible including configurations in which the input surface 14 of the light guide 12, rather than butting against the mechanical stop 38 located at the end of a slotted opening 72 of the thermal housing 32, in some other way engages the thermal housing 32 to provides overall positioning for the light guide 12, particularly with respect to the LEDs 36. Consequently, without departing from the spirit and scope of the disclosure, various alterations, modifications, and/or alternative applications will, no doubt, be suggested to those skilled in the art after having read the preceding disclosure. Accordingly, it is intended that the following claims be interpreted as encompassing all alterations, modifications, or alternative applications as fall within the true spirit and scope of the disclosure including equivalents thereof. In effecting the preceding intent, the following claims shall:
1. not invoke paragraph 6 of 35 U.S.C. §112 as it exists on the date of filing hereof unless the phrase “means for” appears expressly in the claim's text;
2. omit all elements, steps, or functions not expressly appearing therein unless the element, step or function is expressly described as “essential” or “critical;”
3. not be limited by any other aspect of the present disclosure which does not appear explicitly in the claim's text unless the element, step or function is expressly described as “essential” or “critical;” and
4. when including the transition word “comprises” or “comprising” or any variation thereof, encompass a non-exclusive inclusion, such that a claim which encompasses a process, method, article, or apparatus that comprises a list of steps or elements includes not only those steps or elements but may include other steps or elements not expressly or inherently included in the claim's text.

What is claimed is:

1. A method for illuminating a printed graphic with light emitted from an illumination surface of a light guide, the method comprising the step of arranging a plurality of light emitting diodes (“LEDs”) so that light emitted therefrom impinges upon an input surface of the light guide, the LEDs emitting light that is roughly equivalent to solar illumination of 6500K CCT yet enhanced in the blue and the red portions of the spectrum thereby producing light in the range of 7500K CCT to 9000K CCT.

2. A method for illuminating a printed graphic with light emitted from an illumination surface of a light guide, the method comprising the step of arranging a plurality of LEDs so that light emitted therefrom impinges upon an input surface of the light guide, the LEDs emitting 7500K CCT to 9000K CCT light that is augmented in the long wavelength red portion of the spectrum.

3. The method of claim 2 wherein the wavelength of the augmenting red light exceeds 63.0 nm.

4. The method of claim 2 wherein the wavelength of the augmenting red light exceeds 650 nm.

5. A method for illuminating a printed graphic with light emitted from an illumination surface of a light guide, the method comprising the step of arranging a plurality of LEDs so that light emitted therefrom impinges upon an input surface of the light guide, the LEDs emitting light that is perceived as roughly Northern European midday solar illumination of 6500K CCT yet enhanced both in the blue and in the long wavelength red portions of the spectrum thereby producing light in the range of 7500K CCT to 9000K CCT.

6. The method of claim 5 wherein the wavelength of the enhancing red light exceeds 630 nm.

7. The method of claim 5 wherein the wavelength of the enhancing red light exceeds 650 nm.
